(19) United States
(12) Patent Application Publication
(10) Pub. No.: US 2013/0101799 A1
(43) Pub. Date: Apr. 25, 2013

(54) PROCESS FOR PRODUCING A MOULDING AND MOULDING

(71) Applicant: Martin Trier, Michelau (DE)

(72) Inventor: Martin Trier, Michelau (DE)

(73) Assignee: KUNSTSTOFF-TECHNIK SCHERER & TRIER GMBH & CO KG, Michelau (DE)

(21) Appl. No.: 13/807,331

(22) PCT Filed: Jul. 1, 2011
(86) PCT No.: PCT/EP11/61121

§ 371 Date: Dec. 28, 2012

(30) Foreign Application Priority Data
Jul. 2, 2010 (DE) 10 2010 030 911.7

(51) Int. Cl. B29C 45/00

(52) U.S. Cl. CPC B29C 45/0003
USPC 428/164; 264/255; 425/515; 428/161

(57) ABSTRACT

The invention provides a process for producing a moulding (10), in particular a motor vehicle moulding, a visible side (16) of the moulding (10) having a cover part (12) which is back injection moulded with a plastics material (14), and a film (26) being arranged between the cover part (12) and the back injection moulded plastics material (14), wherein the process comprises the following steps: production of at least one recess (22) in the cover part (12), application of the film (26) onto the cover part (12) so that the film (26) covers the at least one recess (22) in the cover part (12), and back injection moulding of the film (26) with the plastics material (14).

The present invention relates to a process for producing a moulding, in particular a motor vehicle moulding, a visible side of the moulding having a cover part which is back injection moulded with a plastics material, and a film being arranged between the cover part and the back injection moulded plastics material. The invention also relates to a moulding which comprises a cover part back injection moulded with a plastics material.

Mouldings of the aforementioned type have diverse uses as cladding elements, decorative elements, coverings or the like. In particular, they are used in motor vehicles to clad or decorate parts of the body or interior of the vehicle. A side of the moulding comprising the back injection moulded plastics material is generally used for mounting the moulding on a superior structure, for example on a vehicle body, while the side of the cover part remote from the back injection moulded plastics material is configured as a visible surface, for example it bears decorative elements or lettering or it has a high-gloss surface.

A metallic visible surface is preferred for many uses, thus a metal sheet is used as the cover part. However, since the injected plastics material does not easily join with the metal of the cover part with adequate strength, it is known to provide the inside of the cover part with an adhesive which can join with the metal of the cover part and also with the back injection moulded plastics material in a material-uniting manner. Thus, FR 2 244 618 proposes a generic process in which a film is arranged between the cover part and the plastics material to be injected, to ensure a rigid connection between the plastics material and the cover part.

Alternatively, it is known to provide an inside of the cover part with an adhesive lacquer which can be activated when it exceeds a predetermined temperature to produce a material-uniting join between a thermoplastic injection moulding plastics material and the metal of the cover part. However, in this case, relatively complex measures are required to heat the adhesive lacquer immediately before the plastics material is injected. For example, it is known to heat an injection mould into which the cover part is introduced to be back injection moulded, in order to activate the adhesive lacquer. However, the heating operation of the mould halves and the subsequent cooling operation required are relatively energy-intensive and result in significantly longer cycle times.

Depending on the purpose of use, it is known to arrange at least one recess in the cover part, for example in order to display a decoration, a character or the like. Thus, motor vehicle trims are known which have a plurality of passage openings to display lettering representing the brand name of the vehicle, so that the plastics material exposed in the region of the recesses is offset in visible contrast compared to the cover part. Furthermore, if an illumination arrangement is arranged behind the injection moulded plastics material and if the plastics material is formed from a transparent material, the light of the illumination means can issue out of the moulding through the plastics material and through the recesses in the cover part and the lettering displayed through the recesses can be configured as illuminated lettering.

The back injection moulding of cover parts which have recesses leads in practice to the problem that when the plastics material is injected into the injection mould, plasticised material penetrates through the recesses and passes into the space between the outside of the cover part and the inside of the injection mould. This results in an undesirable deformation and impairment of the visible surface in the region of the penetrated plastics material.

Against this background, it is the object of the present invention to provide a process and a device for the production of a moulding which operate in a simple and effective manner, and to provide a moulding, in particular a moulding comprising a cover part which has at least one recess, without having to accept a loss of surface quality of the moulding. It is also an object of the invention to provide a moulding which has a high mechanical stability, a high-quality visible surface and which can be produced in a simple and cost-effective manner.

According to a first aspect of the present invention, the object of the invention is achieved by a process for producing a moulding, in particular a motor vehicle moulding, a visible side of the moulding having a cover part which is back injection moulded with a plastics material, and a film, in particular a plastics material film, being arranged between the cover part and the back injection moulded plastics material, the process comprising the following steps: production of at least one recess in the cover part, application of the film onto the cover part so that the film covers the at least one recess in the cover part, and back injection moulding of the film with the plastics material.

According to an important feature of the invention of the first aspect, a recess in the cover part is covered by a film. In this manner, during the injection of the plastics material, the film can be back injection moulded in the region of the cover part and also in the region of the at least one recess and plasticised plastics material can be prevented from passing through the at least one recess and from penetrating inside the space between the outside of the cover part and the inside of the injection mould. However, even if the outside of the cover part is not held by the injection mould but is substantially free, the film spanning over the at least one recess can prevent the plastics material from emerging through the recess. As a result, the process can be carried out in a reliable and effective manner and can allow a moulding to be produced without a loss in quality in the region of the visible surface thereof.

The use of the film allows a rigid and secure material-uniting join between the material of the cover part and the injected plastics material, so that it is possible to obtain a stable moulding. Furthermore, the film can be applied over the inside of the cover part, regardless of the at least one recess, i.e. in spite of the relatively complicated shape of the cover part due to the recess, the film can have a simple shape, in particular it can be a continuous layer or web, and thus can be provided in a cost-effective manner. The film can also be applied to the cover part in a simple manner, because the film can simply be guided over the at least one recess. In particular, it is unnecessary to provide the at least one recess which is in the cover part in the film as well. Therefore, overall, the process according to the invention operates efficiently and economically.

In a preferred embodiment of the invention, the cover part is arranged in an injection mould to be back injection moulded, an inner surface, facing the cover part, of the injection mould covering the at least one recess. This measure means that, when the cover part is back injection moulded, the introduced, plasticised material in the region of the at least one recess presses the film slightly outwards into the at least one recess, the film then resting against the inner surface of the injection mould and assuming the contour of the inner surface of the injection mould. Thus, the film receives with the back injection moulded plastics material a defined shape corresponding to the inner surface of the injection mould. In particular this embodiment of the process according to the invention allows a moulding to be produced, the surfaces of which in the region of the cover part and in the region of the at least one recess have contours which are substantially continuous relative to one another. In other words, a surface of the cover part in a region adjacent to the at least one recess is continued in a substantially continuous manner by a surface of the film back injection moulded with plastics material inside the recess, thereby producing a substantially planar overall surface of the moulding.

The film is preferably applied to the inside of the cover part remote from the visible side by lamination or coating. The laminating or coating procedure can be carried out, for example, using a roll for pressing the film onto the cover part. If an active surface of the roll is greater than a dimension of the at least one recess, then the roll can simply roll over the at least one recess, so that the film covers the recess. To activate an adhesive arranged between the film and the cover part, the film and/or the cover part can be heated. Alternatively, an adhesive which does not require activation can be employed between the film and the cover part, so that it is possible to dispense with special means for activating the adhesive, in particular for heating the adhesive.

Particularly preferably, the step of back injection moulding is carried out in an injection mould and, before reaching the injection mould, the film is applied to the inside of the cover part by lamination or coating. If the film is laminated/coated onto the cover part before the film reaches the injection mould, the lamination/coating step can be carried out in a separate lamination/coating station, in particular in parallel with the back injection moulding of another moulding, so that cycle time can be saved. A particular advantage is afforded when a temperature-activated adhesive lacquer is used between cover part and film. The adhesive lacquer could then be heated and thereby activated using specialised and efficient tools in the separate lamination/coating station, for example using heatable laminating/coating rolls, so that a time-consuming and energy-intensive heating procedure inside the injection mould can be omitted. Upon entering the injection mould, the cover part and film are then already firmly joined together.

Particularly advantageously, the process of the present invention can also produce a moulding, the cover part of which has at least one cover part island which is separated from the rest of the region of the cover part by the at least one recess. Cover part islands of this type are produced, for example, when recesses are configured as characters, such as “A” or “B”, in which the recesses depicting the characters run completely around a portion of the cover part, so that parts of the cover part remain as cover part islands. In a preferred embodiment of the process according to the invention, cover part islands of this type can be handled particularly precisely and easily at the same time, in that the at least one cover part island is joined with the film and is held in position by the film during the back injection moulding step of the cover part. The film can then assume the additional task of retaining the cover part islands in the correct position during back injection moulding or also, if appropriate, when the cover part is transported to an injection moulding station. Specific retaining means for holding the cover part islands thus do not have to be used and the cover part islands can also be positioned very precisely.

In addition to its function as an adhesive and, if appropriate, also as a retaining means for cover part islands, the film can acquire a further function of protecting the back injection moulded plastics material which is arranged under the film. If in particular the surface of the film has a greater mechanical stability, in particular a greater scratch resistance, than the surface of the back injection moulded plastics material, then the wear of the moulding can be reduced, without restricting the configuration freedom in respect of the at least one recess. Alternatively or in addition, the film can have particular visual, physical, chemical or haptic characteristics and can thereby assume in particular a decorative function.

In a further preferred embodiment, the back injection moulded plastics material and the film can be transparent or semi-transparent, so that light from an illumination means can pass at least to some extent through the back injection moulded plastics material and the film in order to issue through the at least one recess. In addition, the back injection moulded plastics material and/or the film could have luminescent characteristics, i.e. they could themselves form a light source from which light emanates, due to electroluminescence or fluorescence or phosphorescence, and issues out of the at least one recess through the film. A moulding having illuminated recesses, for example having illuminated lettering, can be produced by the above-mentioned variant of the invention.

As mentioned above, the at least one recess can be produced in the process according to the invention by a punching process which is cost-effective, particularly in the production of relatively large quantities. Alternatively or in addition, recesses could be produced by drilling and/or cutting and/or sawing. The at least one recess can be produced in a particularly precise manner by laser cutting, but in principle all separating processes known to a person skilled in the art are suitable. Since the film is only attached to the cover part after the production step of the at least one recess, the recess can be produced using simple, in particular conventional means, without special precautions being taken to prevent the film from being damaged, so that the tool which is used to produce the recess can completely sever the material of the cover part in a reliable manner.

According to a second aspect of the invention, the object of the invention is achieved by a process for producing a moulding, in particular a motor vehicle moulding, a visible side of the moulding having a cover part which is back injection moulded with a plastics material and a film being arranged between the cover part and the back injection moulded plastics material, the process comprising the following steps:
feeding a running cover-part strip material;
feeding a running film strip material, in particular a plastics film strip material;
applying, in particular laminating or coating, the film strip material onto an inside of the cover-part strip material;
back injection moulding the two joined-together strip materials from the film side with the plastics material in an injection mould;
transporting a moulding strip material formed from the two joined-together strip materials and the back injection moulded plastics material out of the injection mould to a finishing station; and
separating a portion, forming the moulding, of the moulding strip material from a peripheral portion of the moulding strip material in the finishing station.

According to the second aspect of the invention, the cover parts of a plurality of successively produced mouldings as well as the film are fed in each case as continuous strip materials, so that large quantities can also be produced in a continuous or virtually continuous manufacturing operation. The individual mouldings are only separated from the strip material at a relatively late stage in the process, in particular after passing through the injection mould. Since the transportation of a cohesive material is possible in a positionally accurate manner using comparatively simple means, this measure can play a part in reducing the technical outlay in the production plant. In particular, the number of gripping tools for conveying individual mouldings between the processing stations can be reduced; instead, a continuous strip of material runs through at least a plurality of the processing stations.

Process features of the first and second aspects are preferably used combined together to achieve the advantages and effects indicated above in each case for the features. Thus, it is particularly proposed for the process of the second aspect that it also includes a step of producing at least one recess in the cover part strip material and, in the step of applying the film strip material, this material is applied onto the cover part strip material such that the film strip material covers the at least one recess.

According to a third aspect of the present invention, the above-mentioned object of the invention is achieved by a moulding, in particular by a motor vehicle moulding, a visible side of the moulding having a cover part which is back injection moulded with a plastics material and a film, in particular a plastics material film, being arranged between the cover part and the back injection moulded plastics material, and the cover part having at least one recess, the film covering the at least one recess.

A moulding of this type can be produced economically and in a high quality for the reasons stated above in connection with the process of the first aspect of the invention, since the film covering the at least one recess allows a simple back injection moulding of the cover part and at the same time allows a secure and stable join between the back injection moulded plastics material and the cover part. Thus, the moulding of the third aspect is mechanically stable and can be produced economically. Furthermore, by choosing a suitable material for the film, a surface of the moulding in the region of the at least one recess can be adapted to the appropriate requirements of the application and does not depend on the plastics material which is suitable for back injection moulding. In particular, the mechanical stability and the visual surface quality of the film can be chosen independently of the back injection moulded plastics material.

In a preferred embodiment of the moulding of the third aspect, a surface of the cover part in the region next to the at least one recess is continued in a substantially continuous manner by a surface of the film, back injection moulded with plastics material, inside the recess, thereby producing a surface of the moulding which is substantially smooth and stepless over the at least one recess, thereby further enhancing the quality of the moulding.

The cover part preferably has a metallic visible surface and is formed in particular from a metal sheet. Metallic visible surfaces have a particularly attractive appearance, for example for motor vehicle mouldings. The advantages according to the invention are particularly important for metal sheets as the cover part, because the join between metal and thermoplastic polymer is influenced significantly by the use of an adhesive. Mouldings according to the invention or mouldings which are produced according to the invention can be manufactured to have a particularly low weight if for example a relatively thin metal sheet, in particular an aluminium sheet, is used as the cover part, the necessary mechanical stability of the moulding being provided by the back injection moulded plastics material. Thus, for example, it is possible to achieve reductions in weight by up to approximately 50 percent compared to conventional mouldings.

The moulding of the third aspect of the invention is preferably produced by a process according to the first and/or second aspect of the invention, so that the advantages and effects described above in connection with the different variants of the process of the first and second aspect are expressed as reduced production costs and as an improved appearance of the moulding of the third aspect of the invention.

A preferred application example of a moulding of the invention is a sill trim which is to be fitted in the sill region of a vehicle door. Particular quality criteria apply to a vehicle sill trim in respect of the visible surface, at the same time the production costs in vehicle construction playing a critical part and it being possible for the financial savings which can be achieved according to the invention to be particularly advantageous here. Cover parts are considered here in particular, the recesses of which exhibit decoration or lettering, in particular lettering with cover part islands. At the same time, a sill trim will be exposed to frequent high mechanical stresses during its service life, so that the stable join between the back injection moulded plastics material and the cover part, in particular the cover part islands, can be used in a particularly advantageous manner by means of the film inserted according to the invention.

According to a fourth aspect, the present invention provides a device which comprises a moulding according to the third aspect of the invention and also an illumination arrangement, said illumination arrangement being positioned on the side of the film remote from the cover part, particularly in or behind the injected plastics material, to allow light to issue out of the moulding through the film and the at least one recess. By means of a device of this type, the moulding can be used in particular as a decorative element, for which the at least one recess, for example lettering formed by recesses, can be perceived as a luminous contour. The film allows a secure and rigid join between the cover part and the back injection moulded plastics material and in particular can prevent the penetration of water through the at least one recess and can prevent damage to the illumination arrangement.

According to a fifth aspect of the invention, the object of the invention is achieved by a device for the production of a moulding, in particular a motor vehicle moulding, a visible side of the moulding having a cover part which is back injection moulded with a plastics material and a film being arranged between the cover part and the back injection moulded plastics material, the production device comprising: a separating means for producing at least one recess in the cover part, a laminating means or a coating means for applying the film to the cover part, so that the film covers the at least one recess in the cover part, and an injection mould for back injection moulding the film with the plastics material. Using a production device of the fifth aspect of the invention, a process according to the first and/or second aspect of the invention in particular can be implemented or a moulding or device according to the third or fourth aspect of the invention can be produced.

In the following, the invention will be described in more detail on the basis of preferred embodiments with reference to the accompanying drawings, in which:

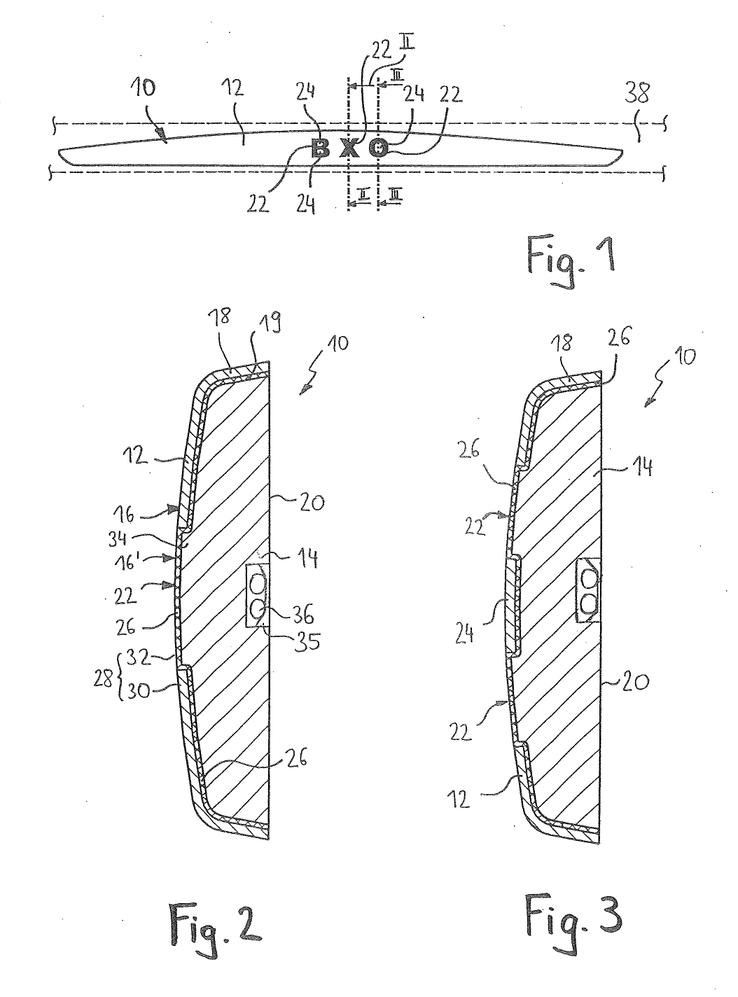

FIG. 1 is a plan view of a moulding according to a first embodiment of the invention;

FIG. 2 is a sectional view of the moulding, shown in FIG. 1, along a line II-II in FIG. 1;

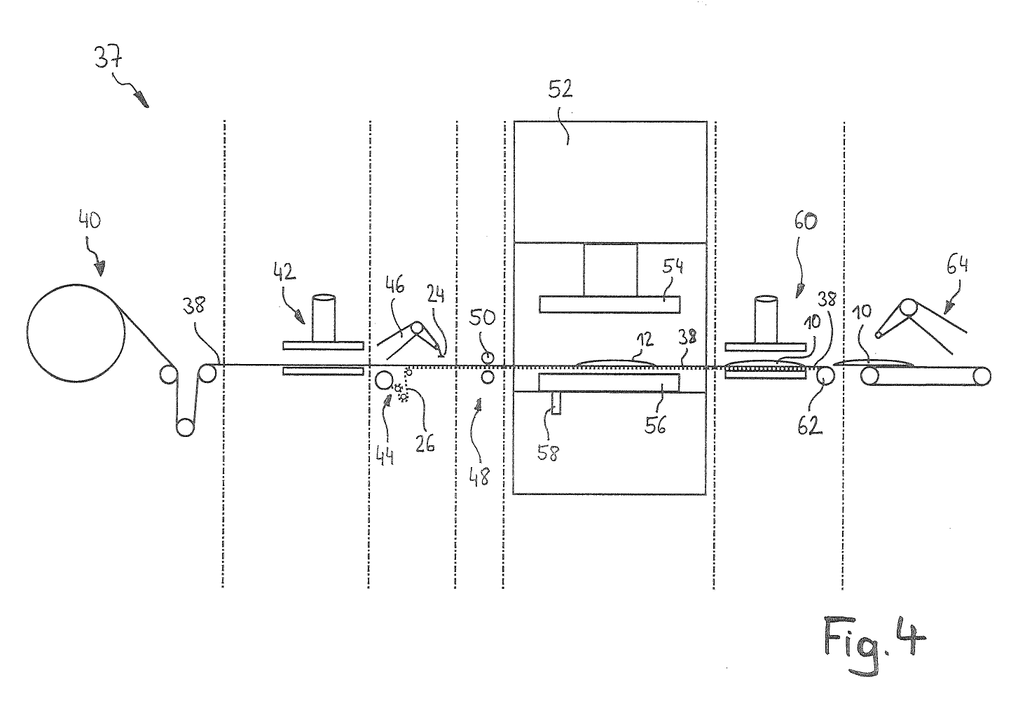

FIG. 3 is a sectional view of the moulding, shown in FIG. 1, along a line III-III in FIG. 1;

FIG. 4 is a schematic overall view of a manufacturing plant for the production of the moulding, shown in FIG. 1, by a process according to an embodiment of the present invention;

FIGS. 5 to 7 are in each case partial sectional views according to FIG. 2 of a moulding according to a second, a third and a fourth embodiment of the present invention.

A moulding, generally designated by reference numeral 10, according to a first embodiment of the invention is shown in FIGS. 1 to 3 and comprises a cover part 12 and a carrier part 14. On its outside, the cover part 12 forms a visible surface 16 having a surface which is accordingly of a high visual quality. On the other hand, the carrier part 14 is preferably used for mounting the moulding 10 on a superior structure and, for this purpose, can have for example mounting portions, such as mounting holes or projections or the like. A mounting of the moulding 10 by means of a clip retainer, pins or even adhesive tape is considered in particular.

In the embodiment, the moulding 10 can be a sill trim to be fitted in the sill region of a vehicle door. For a high quality visual impression, decorative elements having a metallic surface are preferred in this region. In the embodiment, the cover part 12 is a metal sheet, for example an aluminium sheet.

The moulding 10 can have overall an oblong shape, and in the embodiment, the cover part 12 is curved in a convex, shell-shaped manner and, in particular, peripheral portions 18 of the cover part 12 also cover peripheral portions 19 of the carrier part 14. However, any other shape of the cover part 12, including for example concave segments, is also conceivable. If the moulding 10 is attached by a mounting surface 20, remote from the visible surface 16, of the carrier part 14 to a superior structure, for example to a portion of a vehicle body, then only the visible surface 16, formed by the cover part 12, is basically to be seen.

The cover part 12 has at least one recess 22 in the visible surface 16 thereof. In the example of FIGS. 1 to 3, a plurality of recesses 22 corresponding to the contour of the characters B, X and O is provided as corresponding holes through the cover part 12. Of course, any other lettering, signs, patterns or decorative elements can be displayed through appropriate recesses.

If a recess 22 in the cover part 12 runs completely around a portion of the cover part 12, as is the case, for example, for the characters B and O in the embodiment, then the recess 22 runs around a cover part island 24, i.e. a portion of the cover part 12 which is not joined to other parts of the cover part 12, in particular is separated from the main part of the cover part 12 in which the recesses 22 are made. As can be seen in FIG. 1, for example to present the character B, the recess 22 forms two cover part islands 24 and to present the character O, the recess 22 runs round a central cover part island 24, which is shown in a sectional view in FIG. 3.

FIGS. 2 and 3 also show that a film 26 is arranged between the cover part 12 and the carrier part 14. The film 26 substantially extends over the entire boundary surfaces between cover part 12 and carrier part 14. However, according to the invention, the film 26 also extends over the recesses 22 in the cover part 12. This means that the film 26 forms a visible surface 16′ of the moulding 10 in the region of the recesses 22.

As can be seen in FIGS. 2 and 3, the visible surface 16 of the cover part 12 in a portion adjacent to the recess 22 and the visible surface 16′ of the film 26 in the region of the recess 22 extend substantially continuously relative to one another. In particular, there is no step, shoulder or bend in a transitional portion 28 between a peripheral portion 30, delimiting the recess 22, of the cover part 12 and a peripheral portion 32 of the film 26 arranged in the recess 22, but the surface of the moulding 10 continues substantially uniformly or continuously from the visible surface 16 of the cover part 12 into the visible surface 16′ of the film 26 arranged in the recess 22. To achieve this, in the region of the recess 22, the film 26 is turned over to some extent (namely by the amount of the thickness of the cover part 12) into the recess 22. In the embodiment, the thickness of the film 26 is less than the thickness of the cover part 12, so that a projection 34 of the carrier part 14 also projects into the recess 22, the height of the projection 34 corresponding to the difference between the thickness of the cover part 12 and the thickness of the film 26. Thus, overall a substantially smooth and stepless visible surface of the moulding 10 is produced.

An illumination device 35 which, in the embodiment, comprises a plurality of luminous elements 36, preferably light emitting diodes, can be arranged on the side of the carrier part 14 remote from the cover part 12. In this connection, the carrier part 14 and the film 26 can be formed from a transparent or semi-transparent plastics material, so that light emitted by the illumination device 35 can emerge through the carrier part 14 and the film 26 and out of the recesses 22. The recesses 22 and in particular the lettering formed by said recesses 22 then appear illuminated.

In the following, an embodiment of a process for producing the moulding 10 will be described with reference to FIG. 4. FIG. 4 shows stations of the process in a schematic or pictograph-like view.

In a production plant 37 shown in FIG. 4, a metal strip 38 is fed continuously from a strip feed means 40 and passes through a punching station 42 where the recesses 22 are punched out of the metal 38. For the embodiment shown in FIG. 1, three recesses are punched out to present the characters B, X and O, whereupon the metal strip 38 is drawn further by an amount corresponding at least to the length of the moulding 10 to be produced, in order to punch out the recesses 22 in the next moulding 10. Alternatively, the recesses 22 could be made by sawing, drilling, by laser cutting or by another process.

In a next step of the process, film 26 is fed continuously as web material from a film feed means 44 and, in the embodiment according to FIG. 4, is brought from below into contact with the metal strip 38. The film 26 is preferably a continuous strip, the width of which preferably corresponds to the width of the metal strip 38 and thus substantially completely covers the metal strip 38. In particular, the film 26 runs over the previously punched recesses 22.

Thereafter, in a further step of the process, the cover part islands 24, punched out by the punching means 42, are again arranged in their correct position in the metal strip 38, i.e. in the position they occupied before the punching procedure. For this purpose, a gripping tool can be used which is controlled by a robotic arm 46. Since the film 26 was previously arranged under the metal strip 38, the cover part islands 24 can now rest on the film 26 and thus can be further transported together with the metal strip 38 and the film 26. Additional measures are also conceivable to provisionally fix the cover part islands 24 in their desired position, for example to provisionally bond them adhesively to the film 26.

In a following step of the process, the film 26 can be joined to the side of the metal strip 38 forming the inside of the cover part 12 (lower side in FIG. 4) by lamination or coating in a laminating/coating station 48. For this, a laminating process or a coating process using an adhesive lacquer to be arranged between the film 26 and the cover part 12 is particularly preferred. The adhesive lacquer can be a lacquer which is activated in the laminating/coating station 48, for example by being heated temporarily, to firmly bond the film 26 to the metal strip 38. The adhesive lacquer can be applied directly in the laminating/coating station 48 or also beforehand, for example with the feed of the film 26. However, it is particularly preferred for the metal strip 38, fed from the strip feed means 40, to already bear a heat-activated adhesive lacquer.

In the laminating/coating station 48, the film 26 and cover part 12 are joined together flatly and firmly, the film 26 also covering the recesses 22 after the lamination or coating procedure. The film 26 thus runs without interruptions over the recesses 22. In the embodiment of FIG. 4, two rolls 50 can be seen which can be heated, for example, to activate the adhesive. The rolls 50 enclose the film 26 and the metal strip between them and roll over the recesses 22 during lamination or coating. After lamination or coating, the film 26 and the cover part 12 are preferably bonded together over their entire contact surface, particularly also in the peripheral portions 30 near the recesses 22. The cover part islands 24 are also firmly joined to the film 26.

In a further step of the process, the metal strip 38 joined to the film 26 is transported into an injection moulding machine 52, which is schematically illustrated in FIG. 4 by an upper mould half 54, a lower mould half 56 and an injection nozzle 58. When the mould is closed, mutually facing sides (for example with concave cavities) of the mould halves 54, 56 together form a mould cavity, the shape of which corresponds to the outer contour of the moulding 10 to be produced. The metal strip 38 with the film 26 is introduced between the open mould halves 54, 56 and the mould halves 54, 56 are moved towards one another and closed. Plasticised thermoplastic polymer is then injected by the nozzle 58 into the mould cavity between the halves 54, 56, more precisely into the space or gap between the film 26 and the lower mould half 56.

The injected plastics material can join immediately with the film in a material-uniting manner, since the film 26 is also produced from plastics material. For its part, the film 26 has already been firmly joined to the cover part 12 in the preceding laminating or coating step. In particular, a possible activation of an adhesive between film 26 and cover part 12 has already been carried out in the laminating/coating station 48, for example by increasing the temperature. Activation of adhesive in the injection mould 54, 56 is therefore no longer necessary. In particular, it is possible to dispense with measures for heating the adhesive lacquer inside the injection mould, for example by a relatively expensive heating procedure, known per se in the prior art, of one of the mould halves 54, 56.

In principle, it is possible that using the described process, a moulding having a substantially planar visible surface is produced, so that the upper mould half 54 is substantially plate-shaped and does not have a cavity. However, a moulding having a curved surface is often to be produced, for example with the convex, shell-shaped curvature, shown in FIGS. 1 to 3, on the cover part 12. The substantially flat metal strip 38 can be formed into the desired shape in a step preceding the injection moulding step (for example after lamination or coating) by bending or cold forming processes. Particularly preferably, however, the metal strip 38 is directly formed in the injection moulding machine 52. The pressure of the plasticised material, which penetrates into the mould cavity through the nozzle 58, can urge the metal strip 38 towards the upper mould half 54 until the metal strip 38 rests against the inside of the upper mould half 54 and assumes the contour thereof. The forming of the metal strip 38 into the desired shape of the cover part 12 corresponding to the inside of the upper mould half 54 and the injection of the plasticised material can then take place at the same time.

After the injected plastics material has cooled to a predetermined mould-release temperature, the mould halves 54, 56 are reopened and the now moulded metal strip 38 which has been back injection moulded with the plastics material is further transported to a finishing station 60. In the described embodiment, the transportation of the materials through the production plant 37 is particularly simple, since a continuous metal strip 38 with a film 26 firmly laminated/coated thereon is to be transported as far as the finishing station 60. In particular, the introduction into the injection moulding machine 52 and the removal from the mould and discharge from the injection moulding machine 52 are greatly simplified by the guidance of the continuous strip material. To illustrate this transportation principle, the edge of the continuous metal strip 38 is indicated by dashed lines in FIG. 1. Thus, FIG. 1 corresponds to a plan view of the metal strip 38 or of the moulding 10 which has not yet been separated from the metal strip 38, more specifically for example in a state after leaving the injection moulding machine 52 and before the finishing station 60.

In the finishing station 60, the metal strip 38 is then separated, for example die-cut, along the contour of the moulding 10 to be produced, i.e. on the peripheral portion 18 of the cover part 12. The remainder of the metal strip 38 can still form a cohesive strip, from which the respective moulding 10 is punched, so that the remaining strip 38 can be easily removed on a strip removal means 62, for example it can be wound up onto a roll.

After leaving the finishing station 60, a moulding 10 is produced which has substantially the shape described with reference to FIGS. 2 and 3. In a following moulding processing station 64, the moulding 10 can be subjected to further finishing steps, for example surface sealing or packaging.

In particular, the illumination device 35 can be mounted on the carrier part 14 in the moulding processing station 64. Alternatively, the illumination device 35 could be cast at least partly in the plastics material of the carrier part 14, for which purpose parts of the illumination device 35 would have to be introduced into the lower mould half 56 of the injection moulding machine 52.

Any plastics material which can be processed in the injection moulding process, in particular any thermoplastic polymer, is possible as the material for the carrier part 14. The choice of material depends, for example, on the requirements of the carrier part in respect of the mounting of the moulding 10 on a superior structure. In principle, any plastics material which can be processed into a film form and on which the thermoplastic polymer of the carrier part 14 can be injected can be considered as material for the film 26. Examples of thermoplastic polymers which could be used for the carrier part 14 and/or for the film 26 are polymethylmethacrylate (PMMA) or polycarbonate (PC) or acrylonitrile-butadiene-styrene (ABS) or other plastics materials known per se in the production of injection moulded mouldings. It would also be possible to use the same plastics material for the carrier part 14 and the film 26.

It should be noted that the forming of the cover part 12 into its desired shape during the injection of the plastics material has been described above as a preferred embodiment. Of course, within the scope of the invention, the cover parts 12 can also be shaped before injection moulding, in particular by any shaping process known per se. The cover parts 12 could also be moulded before the film 26 is applied, for example instead of the metal strip 38, preformed cover parts 12 could be supplied to the process, which preformed cover parts 12 can be transported between the processing stations by gripping tools (for example robots).

With reference to FIGS. 5 to 7, a second, third and fourth embodiment of a moulding of the present invention are described in the following, which embodiments are variants of the first embodiment. Identical elements or elements analogous to those in the first embodiment are designated by the same reference numerals in FIGS. 5 to 7. In the following, only the differences compared to the first embodiment will be described in detail, reference being made explicitly to the correspondingly applicable description of the first embodiment in respect of the other features and characteristics.

FIG. 5 shows a second embodiment of a moulding 10, comprising a cover part 12, a film 26 which substantially completely covers the inside of the cover part 12 and also extends over recesses 22 in the cover part 12, and also a carrier part 14 which is arranged on the side of the film 26 remote from the cover part 12. A visible surface 16, 16′ of the moulding 10 is formed by an outside of the cover part 12 and in the region of the recesses 22 by an outside of the film 26.

Unlike the first embodiment, the carrier part 14 in the second embodiment is injected from two different plastics components, in particular in a two-component injection moulding process. In this respect, a first plastics component 14a is firstly injected which covers a portion of the film 26 in the region of the recesses 22 as well as in the regions adjacent to the recesses 22, while an outer peripheral portion 66 of the film 26 which covers a peripheral portion 18, running around the moulding 10, of the cover part 12, does not come into contact with the first plastics component 14a. The second plastics component 14b is then injected onto the first plastics component 14a and, in so doing, also covers the outer peripheral portion 66. In a configuration of this type, the first plastics component 14a can only be seen from outside through the recesses 22 but, from the mounting surface 20, it is completely covered by the second plastics component 14a.

In the second embodiment, an illumination device 35 having an illumination element 36 can be arranged between the first plastics component 14a and the second plastics component 14b, for example it can be directly integrated into the carrier part 14 during the injection moulding step. In FIG. 5, the illumination device 35 is located in a cavity, open towards the first plastics component 14a, in the second plastics component 14b. The first plastics component 14a and the film 26 are then formed from transparent plastics material, so that light issuing from the illumination device 35 can pass through the first plastics component 14a and the film 26 and can emerge through the recess 22. The second plastics component 14b is preferably formed from a non-transparent plastics material, so that scattered light cannot escape through the mounting surface 20 and cannot issue over the edge of the moulding 10, for example where there are mounting inaccuracies.

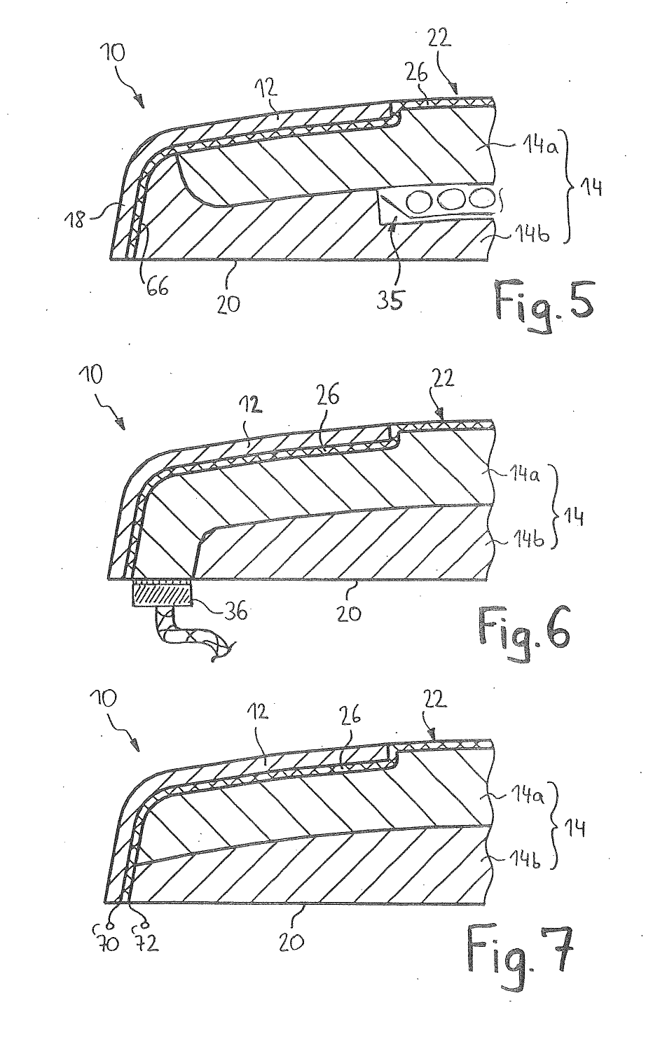

In the third embodiment of the invention shown in FIG. 6, the moulding 10 also comprises a cover part 12, a film 26 and a carrier part 14 which is produced by two-component injection moulding and has a first plastics component 14a and a second plastics component 14b. Unlike the second embodiment, in the third embodiment the first plastics component 14a also covers a peripheral region 66 of the film 26 and thereby extends as far as the mounting surface 20 of the moulding 10. If the first plastics component 14a is formed from a transparent plastics material, then with the third embodiment it is possible to achieve the advantage that light from an illumination device 35 can also be conducted from the mounting surface 20 into the first plastics component 14a, for example by means of an optical waveguide 36, and can issue as diffuse, uniform light out of the recesses 22 due to internal light scattering or multiple reflection. In particular after the injection moulding step, the illumination device 35 can then also be fitted in the finishing station 60 or in the moulding processing station 64.

In the fourth embodiment of the present invention shown in FIG. 7, a moulding 10 also comprises a cover part 12 with recesses 22, a film 26 covering the inside of the cover part 12 and also covering the recesses 22, as well as a carrier part 14 which is produced by two-component injection moulding. A first plastics component 14a and a second plastics component 14b are injected one above the other substantially as plate-shaped layers in the carrier part 14. Due to a convex curvature of the cover part 12 in its outer encircling peripheral portion 18, which gives the cover part 12 an approximately shell-shaped form, an outer peripheral portion 66 of the film 26 located close to the mounting surface 20 is only contacted by the second plastics component 14b, injected second, so that in the fourth embodiment as well, the first plastics component 14a cannot be seen from the mounting surface.

In the fourth embodiment, the recesses 22 can be illuminated using an electroluminescent film as the film 26. An electroluminescent film of this type carries on the opposite sides thereof in each case thin electrode layers, for example consisting of semi-transparent metal evaporated thereon, the plastics material enclosed between the electrodes having electroluminescent characteristics, so that when a voltage is applied between the electrodes by contacts 70, 72, the film 26 located between the electrodes becomes luminescent. Thus, in this variant, the film 26 simultaneously acts as an illuminant.

The features of the described embodiments one to four can be combined with one another in any desired manner. In particular, the different variants of the illumination device can be used in a moulding of any of the embodiments, so that for example the electroluminescent film can also be used in the first, second or third embodiment. All the described mouldings can be produced by the process described with reference to FIG. 4.

1-15. (canceled)

16. Process for producing a moulding, a visible side of the moulding having a cover part which is back injection moulded with a plastics material forming a carrier part, peripheral portions of the cover part covering peripheral portions of the carrier part, and a film being arranged between the cover part and the back injection moulded plastics material, characterised in that the process comprises the following steps:
production of at least one recess in the cover part,
application of the film onto the cover part so that the film covers the at least one recess in the cover part, and
back injection moulding of the film with the plastics material.

17. Process according to claim 16, characterised in that the back injection moulding step is carried out in an injection mould and in that before reaching the injection mould, the film is applied onto the inside of the cover part by laminating or coating, in particular while increasing the temperature.

18. Process according to claim 16, characterised in that the cover part has at least one cover part island which is separated from the remaining region of the cover part by the at least one recess, the cover part island being brought into contact with the film and being held in position by the film during the injection moulding step of the cover part.

19. Process according to claim 16, characterised in that the back injection moulded plastics material and the film are transparent or semi-transparent and/or have luminescent characteristics.

20. Process according to claim 16, characterised in that the cover part has a metallic visible surface, in particular is formed from a metal sheet.

21. Process according to claim 16, characterised in that the at least one recess is produced by punching.

22. Process for producing mouldings, a visible side of each moulding having a cover part which is back injection moulded with a plastics material, and a film being arranged between the cover part and the back injection moulded plastics material, characterised in that the process comprises the following steps:
feeding a running cover-part strip material;
feeding a running film strip material;
applying, in particular laminating or coating, the film strip material onto an inside of the cover-part strip material;
back injection moulding the two joined-together strip materials from the film side with the plastics material in an injection mould;
transporting a moulding strip material formed from the two joined-together strip materials and the back injection moulded plastics material out of the injection mould to a finishing station; and
separating portions, forming the mouldings, of the moulding strip material from a peripheral portion of the moulding strip material in the finishing station.

23. Moulding, a visible side of the moulding having a cover part which is back injection moulded with a plastics material, peripheral portions of the cover part covering peripheral portions of the carrier part, and a film being arranged between the cover part and the back injection moulded plastics material, characterised in that the cover part has at least one recess, the film covering the at least one recess.

24. Moulding according to claim 23, characterised in that a surface of the cover part is continued in the region of the at least one recess in a substantially continuous manner by a surface of the film back injection moulded with plastics material.

25. Moulding according to claim 23, characterised in that the cover part has at least one cover part island which is separated from the remaining region of the cover part by the at least one recess.

26. Moulding according to claim 23, characterised in that the back injection moulded plastics material and the film are transparent or semi-transparent and/or have luminescent characteristics.

27. Moulding according to claim 23, characterised in that the cover part has a metallic visible surface, in particular is formed from a metal sheet.

28. Moulding according to claim 23, characterised in that the moulding is a sill trim which is to be fitted in the sill region of a vehicle door.

29. Device, comprising a moulding according to claim 23 and also an illumination device which is arranged on the side of the film remote from the cover part to allow light to issue out of the moulding through the film and the at least one recess.

30. Device for the production of a moulding, according to claim 23, the production device comprising:
a separating means for producing at least one recess in the cover part,
a laminating means or a coating means for applying the film to the cover part, so that the film covers the at least one recess in the cover part, and
an injection mould for back injection moulding the film with the plastics material.
